(19) United States
(12) Patent Application Publication
(10) Pub. No.: US 2022/0021744 A1
(43) Pub. Date: Jan. 20, 2022

(54) SYSTEM FOR CONTINUOUS AND INTEGRATED ISOLATION THROUGH DISPARATE TECHNOLOGY IMPLEMENTATIONS OVER FTTX INFRASTRUCTURE

(71) Applicant: Sterlite Technologies Limited, Aurangabad (IN)

(72) Inventors: Saurabh Chattopadhyay, Aurangabad (IN); Badri Gomatam, Aurangabad (IN)

(21) Appl. No.: 17/256,022

(22) PCT Filed: Apr. 1, 2020
(86) PCT No.: PCT/IN2020/050316

§ 371 Date: Dec. 24, 2020

(30) Foreign Application Priority Data
Apr. 8, 2019 (IN) 201921013989

(51) Int. Cl. H04L 29/08; H04L 12/46; H04L 29/06; H04B 10/27

(52) U.S. Cl. CPC H04L 67/2804; H04L 67/1097; H04L 67/327; H04L 67/40; H04B 10/271; H04L 12/4641

(57) ABSTRACT

The present disclosure provides a continuous and integrated isolation system for providing shareable Fibre to the x (FTTx) network infrastructure across one or more tenants. The continuous and integrated isolation system identifies one or more available segmentation technologies in each of a plurality of end-to-end service paths. In addition, the continuous and integrated isolation system encapsulates a segmentation metadata of each of the plurality of end-to-end service paths. Further, the continuous and integrated isolation system establishes a chain of isolation and continuous end-to-end service path corresponding to each of the plurality of tenant services. Furthermore, the continuous and integrated isolation system enables interconnection of each of the one or more disparate technology implementations for seamless transition. Moreover, the continuous and integrated isolation system includes a segmentation capability engine unit, a segmentation meta-data unit and an isolation control function unit.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

### Field of the Invention

The present disclosure relates to the field of networking infrastructure. More particularly, the present disclosure relates to a system for continuous and integrated isolation through disparate technology implementations over a Fiber to the x (FTTx) infrastructure. The present application is based on, and claims priority from an Indian Application Number 201 921 01 3989 filed on 8 Apr. 2019, and PCT/IN2020/050316 filed on 1 Apr. 2020, the disclosures of which is hereby incorporated by reference herein.

### Description of the Related Art

In the last few years, changing infrastructure and business requirements are forcing enterprises to rethink their networks. Enterprises are looking for network infrastructures that increase network efficiency, flexibility, and cost reduction. In this context, Fiber to the x (FTTx) infrastructure has gained much attention in the last few years as a promising solution for enterprise networks. However, existing deployment methods of the FTTx infrastructure for network-sharing mandate maintaining separate fiber strands, optical network units (ONUs), optical line terminal (OLT) cards, and aggregation switches for making disparate technologies such as Ethernet, passive optical network (PON), multi-protocol label switching (MPLS) shareable across multiple tenants or multiple services. Most of the time, this physical separation is entirely un-optimized and unviable. In addition, there is no mechanism available for continued and integrated isolation for all services rolled out over heterogeneous and disparate FTTx infrastructure. Also, there is no mechanism available for re-using end to end infrastructure and carrying out dynamic capacity allocation over the heterogeneous and disparate FTTx infrastructure. In addition, current software defined virtualization technologies have focused on representing virtual resources from physical resources. However, virtual resources realizations are fragmented across network due to implementation of disparate technologies in end-to-end service paths. Also, each technology of disparate technology implementations may have a specific realization of logical or virtual resources. However, the specific realization of logical or virtual resources is restricted within scope of particular technology implementation of each technology of disparate technology implementations.

In light of the above stated discussion, there is a need for a shareable FTTx infrastructure that overcomes the above stated disadvantages.

### BRIEF SUMMARY OF THE INVENTION

In an aspect, the present disclosure provides a method for providing shareable Fibre to the x (FTTx) network infrastructure across one or more tenants. The method includes a first step to identify one or more available segmentation technologies in each of a plurality of end-to-end service paths corresponding to a plurality of tenant services of the one or more tenants. In addition, the method includes a second step to encapsulate a segmentation metadata of each of the plurality of end-to-end service paths corresponding to the plurality of tenant services of the one or more tenants. Further, the method includes a third step to establish a chain of isolation and continuous end-to-end service path corresponding to each of the plurality of tenant services. Furthermore, the method includes a fourth step to enable interconnection of each of one or more disparate technology implementations for seamless transition of traffic. Moreover, the plurality of end-to-end service paths corresponds to the one or more disparate technology implementations. Also, the chain of isolation and continuous end-to-end service path is established through dynamically utilizing the encapsulated segmentation metadata of the plurality of end-to-end service paths. Also, each of the one or more disparate technology implementations is interconnected on the chain of isolation and continuous end-to-end service path.

A primary object of the present disclosure is to provide a system for continuous and integrated isolation through disparate technology implementations for shared FTTx infrastructure.

Another object of the present disclosure is to provide the system to increase scale and capacity of FTTx network infrastructure without duplication of hardware resources.

Yet another object of the present disclosure is to provide the system to enable dynamic and isolated re-use of capacity allocation of FTTx network infrastructure.

Yet another object of the present disclosure is provide the system to enable dynamic and isolated re-use of end to end infrastructure of FTTx network infrastructure.

Yet another object of the present disclosure is provide the system to reduce operating expenses and capital expenses of FTTx network infrastructure.

In an embodiment of the present disclosure, the one or more disparate technology implementations include Ethernet, passive optical network (PON), internet protocol (IP), and active optical networks (AON). In another embodiment of the present disclosure, the one or more disparate technology implementations include optical distribution network (ODN), metro network and multiprotocol label switching (MPLS).

In an embodiment of the present disclosure, the encapsulation of the segmentation metadata and establishment of the chain of isolation and continuous end-to-end service path are hosted over a control plane. In addition, the control plane is available at corresponding data center of a plurality of data centers.

In an embodiment of the present disclosure, the one or more available segmentation technologies are dynamically programmed for each of the one or more disparate technology implementations.

In another aspect, the present disclosure provides a continuous and integrated isolation system for providing shareable Fibre to the x (FTTx) network infrastructure across the one or more tenants. The continuous and integrated isolation system includes a segmentation capability engine unit. In addition, the segmentation capability engine unit is configured to identify the one or more available segmentation technologies. Further, the segmentation capability engine unit identifies the one or more available segmentation technologies in each of the plurality of end-to-end service paths corresponding to the plurality of tenant services. Furthermore, the plurality of end-to-end service paths corresponds to the one or more disparate technology implementations. The continuous and integrated isolation system includes a segmentation meta-data unit. In addition, the segmentation meta-data unit is connected to the segmentation capability engine unit to encapsulate the segmentation metadata. Further, the segmentation meta-data unit encapsulates the segmentation metadata of each of the plurality of end-to-end service paths corresponding to the plurality of tenant services of the one or more tenants. The continuous and integrated isolation system includes an isolation control function unit. In addition, the isolation control function unit is configured to receive the encapsulated segmentation metadata. Further, the isolation control function unit establishes the chain of isolation and continuous end-to-end service path corresponding to each of the plurality of tenant services.

In an embodiment of the present disclosure, the segmentation capability engine unit includes a technology abstraction module. In addition, the technology abstraction module selects the segmentation metadata from repository of the segmentation meta-data unit. The segmentation capability engine unit includes a capability discovery engine. In addition, the capability discovery engine identifies the one or more available segmentation technologies in each of the one or more disparate technology implementations. Further, the one or more available segmentation technologies are used to leveraged to establish tenancy requirement of the plurality of tenant services. The segmentation capability engine unit includes a tenancy handler module. In addition, the tenancy handler module identifies tenancy requirement of the plurality of tenant services. Further, the tenancy handler module matches tenancy requirement with the one or more available segmentation technologies in accordance with the one or more disparate technology implementations.

In an embodiment of the present disclosure, the segmentation meta-data unit encapsulates the segmentation metadata. In addition, the segmentation metadata includes protocol buffer data, remote procedure call (RPC) data, inter-micro services data, and technology implementation profiles. Further, the segmentation metadata includes key-value data, micro-services registry data, state data, SBI data, and NBI data.

In an embodiment of the present disclosure, the isolation control function unit includes a device agent module. In addition, the device agent module allows abstraction over a plurality of devices used in shareable Fibre to the x (FTTx) network infrastructure. Further, the plurality of devices includes optical line terminal (OLT), optical network unit (ONU), customer-premises equipment (CPE) gateways, switch fabric, and aggregation switch. The isolation control function unit includes an adapter agent module. In addition, the adapter agent module allows inter-working of each of the plurality of device. The isolation control function unit includes a logical device agent. In addition, the logical device agent sets logical partitioning of the device agent module based on the one or more available segmentation technologies and the chain of isolation and continuous end-to-end service path. The isolation control function unit includes a technology handler module. In addition, the technology handler module leverages technology requirements of the one or more available segmentation technologies to enforce corresponding encapsulation mechanism. The isolation control function unit includes a chaining handler module. In addition, the chaining handler module establishes the chain of isolation and continuous end-to-end service path corresponding to each of the plurality of tenant services. Further, the chaining handler module maintains tenancy requirement of the plurality of tenant services

### DESCRIPTION OF THE DRAWINGS

In order to best describe the manner in which the above-described embodiments are implemented, as well as define other advantages and features of the disclosure, a more particular description is provided below and is illustrated in the appended drawings. Understanding that these drawings depict only exemplary embodiments of the invention and are not therefore to be considered to be limiting in scope, the examples will be described and explained with additional specificity and detail through the use of the accompanying drawings in which:

FIG. 1 illustrates an interactive computing environment for providing shareable Fibre to the x (FTTx) network infrastructure across one or more tenants, in accordance with various embodiments of the present disclosure;

FIG. 2 illustrates a block diagram of various advantages offered by shareable Fibre to the x (FTTx) network infrastructure across the one or more tenants, in accordance with various embodiments of the present disclosure;

FIG. 3 illustrates a continuous and integrated isolation system for providing shareable Fibre to the x (FTTx) network infrastructure across the one or more tenants, in accordance with various embodiments of the present disclosure;

FIG. 4 illustrates a flowchart for providing shareable Fibre to the x (FTTx) network infrastructure across the one or more tenants, in accordance with various embodiments of the present disclosure; and

FIG. 5 illustrates a block diagram of a computing device, in accordance with various embodiments of the present disclosure.

It should be noted that the accompanying figures are intended to present illustrations of few exemplary embodiments of the present disclosure. These figures are not intended to limit the scope of the present disclosure. It should also be noted that accompanying figures are not necessarily drawn to scale.

### REFERENCE NUMERALS IN THE DRAWINGS

For a more complete understanding of the present invention parts, reference is now made to the following descriptions:
100. Interactive computing environment.
102. First central office.
104. Second central office.
106. First aggregation switch.
108. Second aggregation switch.
110. First optical line terminal.
112. Second optical line terminal.
114. Edge cloud setup.
116. Leaf spine fabric.
118. Compute and storage cluster.
120. Splitters.
122. Tenants.
300. Continuous and integrated isolation system.
302. Segmentation capability engine unit.
304. Segmentation meta-data unit.
306. Isolation control function unit.
400. Flowchart.
402. Start step.
404. Identify one or more available segmentation technologies in each of a plurality of end-to-end service paths corresponding to a plurality of tenant services of one or more tenants.
406. Encapsulate a segmentation metadata of each of the plurality of end-to-end service paths corresponding to the plurality of tenant services of the one or more tenants.
408. Establish a chain of isolation and continues end-to-end service path corresponding to each of the plurality of tenant services through the encapsulated segmentation metadata.
410. Enable interconnection of each of the one or more disparate technology implementations for seamless transition of traffic on the chain of isolation and continuous end-to-end service path.
412. Stop step.
500. Computing device.
502. Bus.
504. Memory.
506. Processors.
508. Presentation components.
510. Input/output (I/O) ports.
512. Input/output (I/O) components.
514. Power supply.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Reference will now be made in detail to selected embodiments of the present disclosure in conjunction with accompanying figures. The embodiments described herein are not intended to limit the scope of the disclosure, and the present disclosure should not be construed as limited to the embodiments described. This disclosure may be embodied in different forms without departing from the scope and spirit of the disclosure. It should be understood that the accompanying figures are intended and provided to illustrate embodiments of the disclosure described below and are not necessarily drawn to scale. In the drawings, like numbers refer to like elements throughout, and thicknesses and dimensions of some components may be exaggerated for providing better clarity and ease of understanding.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

It should be noted that the terms “first”, “second”, and the like, herein do not denote any order, ranking, quantity, or importance, but rather are used to distinguish one element from another. Further, the terms “a” and “an” herein do not denote a limitation of quantity, but rather denote the presence of at least one of the referenced item.

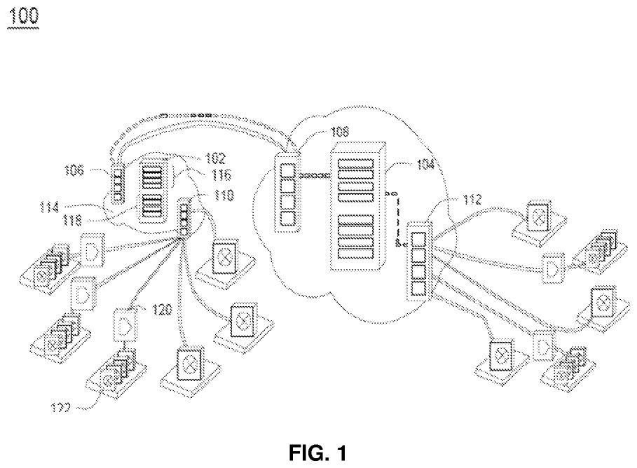

FIG. 1 illustrates an interactive computing environment 100 for providing shareable Fibre to the x (FTTx) network infrastructure across one or more tenants 122, in accordance with various embodiments of the present disclosure. In general, FTTx is a term used for any broadband network architecture using optical fiber to provide all or part of local loop used for last mile telecommunications. In general, optical fiber is a thin fiber of glass or plastic that can carry light from one end to the other. In addition, optical fibers are mainly used in telecommunications and networking. Further, optical fibers are used for lighting, sensors, toys, and special cameras for seeing inside small spaces. In an embodiment of the present disclosure, one or more disparate technology implementations include but may not be limited to Ethernet, passive optical network (PON), internet protocol (IP), and multiprotocol label switching (MPLS).

In general, FTTx stands for Fiber to the x or Fiber to the loop. In addition, FTTx is a generalization for various configurations of fiber deployment. Further, the various configurations of fiber deployment includes a first configuration and a second configuration. The first configuration includes but may not be limited to FTTP, FTTH and FTTB. The FTTP stands for Fiber to the Premises. The FTTH stands for Fiber to the Home. The FTTB stands for Fiber to the Building. The second configuration includes but may not be limited to a FTTC and a FTTN. The FTTC stands for Fiber to the Cabinet. The FTTN stands for Fiber to the Node. However, the various configurations of fiber deployment are not limited to above mentioned configurations.

The present disclosure discloses about providing the programmable Fibre to the x (FTTx) network infrastructure for one or more tenants 122. In general, multiple tenant or multi-tenancy means that single instance of software or service delivery environment and its supporting infrastructure serves multiple customers. The present disclosure also discloses about deploying the shareable FTTx infrastructure without duplication of hardware resources. The present disclosure talks about increasing scale and capacity of the Fibre to the x (FTTx) network infrastructure. In general, scale refers to size or extent of FTTx infrastructure. In general, capacity is amount of traffic which may include service subscription, consumption, modification, sustenance, or an un-subscription requests that a network can handle at any given time. In addition, the capacity is measurement of maximum amount of data that may be transferred between network locations over a link or network path.

The interactive computing environment 100 includes one or more central offices, one or more aggregation switches and one or more optical link terminals. The one or more central offices include a first central office 102 and a second central office 104. The one or more aggregation switches include a first aggregation switch 106 and a second aggregation switch 108. The one or more optical link terminals include a first optical line terminal 110 and a second optical line terminal 112. In addition, the interactive computing environment 100 includes an edge cloud setup 114, a leaf spine fabric 116, and a compute and storage cluster 118. Further, the interactive computing environment 100 includes one or more splitters 120 and the one or more tenants 122.

The interactive computing environment 100 includes the first central office 102 and the second central office 104. In general, central office is initial point of origination of the passive optical network. In addition, the optical fiber is supplied to home or premises of a user from the central office. In general, the central office hosts optical line terminals (OLTs) and optical distribution frames (ODFs). In addition, the central office provides necessary powering and includes some important components of core network. In an embodiment of the present disclosure, the first central office 102 is connected with the second central office 104.

The first central office 102 hosts the edge cloud setup 114. In addition, the second central office 104 hosts the edge cloud setup 114. In general, edge cloud computing is a distributed computing paradigm in which computation is largely or completely performed on distributed device nodes as opposed to primarily taking place in a centralized cloud environment. In addition, the distributed device nodes are known as smart devices or edge devices. In general, edge cloud takes compute capacity at edge of network (near traffic).

Further, the edge cloud setup 114 includes the leaf spine fabric 116 and the compute and storage cluster 118. In general, the leaf spine fabric is a two layer network topology composed of leaf switches and spine switches. In general, servers and storage connects with leaf switches. In addition, the leaf switches connect with the spine switches. Further, the leaf switches aggregate traffic from server nodes and connects to core of network. Furthermore, the leaf switches mesh into the spine switches, forming access layer that delivers network connection points for servers.

Furthermore, the edge cloud setup 114 includes the compute and storage cluster 118. In general, compute is used to handle compute-intensive applications that require large amounts of compute power for extended periods of time. In general, the compute is a term used to refer to one or more resources being used or served up in server and data center spaces. The one or more resources include but may not be limited to memory resource, storage resource, network resource and I/O resource. In general, the storage refers to overall set of hardware and software components needed to facilitate storage for any system. In general, the storage is a technology consisting of computer components and recording media that are used to retain digital data. The compute and storage cluster 118 is responsible for collective working of compute and storage altogether for proper functioning of the edge cloud setup 114.

The first central office 102 hosts the first optical line terminal 110. The second central office 104 hosts the second optical line terminal 112. In general, the optical line terminal is a device which serves as a service provider endpoint of the passive optical network (PON). In general, the passive optical network is a telecommunications technology used to provide optical fiber to end consumer, both domestic and commercial. In addition, the optical line terminal performs conversion between electrical signals used by service provider's equipment and fiber optic signals used by the passive optical network. Further, the optical line terminal coordinates multiplexing between conversion devices on other end of network. The conversion device includes but may not be limited to optical network terminals (ONTs) and optical network units (ONUs).

In an embodiment of the present disclosure, the first optical line terminal 110 and the second optical line terminal 112 are programmed to leverage one or more available segmentation technologies in each of the one or more disparate technology implementations. The existing one or more network segmentation methods are programmed to formulate continuous and isolated versions of a plurality of end-to-end service paths. In an embodiment of the present disclosure, the first optical line terminal 110 is initially programmed with a segmentation capability discovery method. In an embodiment of the present disclosure, the second optical line terminal 112 is initially programmed with the segmentation capability discovery method. The segmentation capability discovery method discovers the one or more available segmentation technologies in each of the one or more disparate technology implementations.

The interactive computing environment 100 includes the one or more aggregation switches. The one or more aggregation switches include the first aggregation switch 106 and the second aggregation switch 108. In an embodiment of the present disclosure, the first aggregation switch 106 in the first central office 102 is connected with the second aggregation switch 108 in the second central office 104. In general, the aggregation switch provides methods of combining multiple network connections in parallel in order to increase throughput beyond what a single connection could sustain. In addition, aggregation switches provide redundancy in case one of the links may fail.

The interactive computing environment 100 includes the one or more splitters 120. In general, the splitters (i.e., optical splitters) split power of signal. In an example, each optical fiber link entering splitter may be split into a given number of optical fibers leaving splitter. The interactive computing environment 100 includes the one or more tenants 122. In general, the tenant is a group of users who share a common access with specific privileges to software instance. In an example, one or more tenants may include users in a business, users in building, users in home, users in a premise, and the like.

The present disclosure talks about providing the shareable FTTx infrastructure across the one or more tenants 122. In an embodiment of the present disclosure, the programmable FTTx infrastructure is shared across a plurality of tenant services. The programmable FTTx infrastructure is shared by dynamically programming the one or more available segmentation technologies in each of the one or more disparate technology implementations.

In an embodiment of the present disclosure, the programmable FTTx infrastructure is useful for telecom operators that own infrastructures and a mobile virtual network operator (MVNO) licenses. In general, the MVNO is a reseller for wireless communications services. In general, the MVNO leases wireless capacity from a third-party mobile network operator (MNO) at wholesale prices and resells it to consumers at reduced retail prices under its own business brand. In another embodiment of the present disclosure, the programmable FTTx infrastructure is useful for government bodies to reuse last mile optics infrastructure. In yet another embodiment of the present disclosure, the programmable FTTx infrastructure is useful for infrastructure companies.

In an embodiment of the present disclosure, queue and scheduler segmentation is leveraged at GPON or xPON part of network for the programmable FTTx infrastructure. In general, queue is a sequence of work objects that are waiting to be processed. In general, Ethernet is a family of computer networking technologies commonly used in local area networks (LANs), metropolitan area networks (MANs) and wide area networks (WANs). The term GPON stands for Gigabit Passive Optical Network. The GPON includes all of its successor technologies. In general, the GPON is a point-to-multi point access mechanism capable of transmitting Ethernet, time division multiplexing (TDM) as well as ATM (asynchronous transfer mode) traffic. In another embodiment of the present disclosure, queue and scheduler segmentation is leveraged at Ethernet and GPON or xPON part of network for Q-in-Q isolation for Ethernet. In general, Q-in-Q isolation allows service providers on Ethernet access networks to extend a layer 2 Ethernet connection between two customer sites. In yet another embodiment of the present disclosure, queue and scheduler segmentation is leveraged at Ethernet and GPON or xPON part of network for tenancy specific SVLAN. In general, the SVLAN stands for Service VLAN. Moreover, the VLAN stands for virtual LAN. In general, the VLAN is a group of devices on one or more LANs that are configured to communicate as if they are attached to same wire, when in fact they are located on a number of different LAN segments. In yet another embodiment of the present disclosure, queue and scheduler segmentation is leveraged at GPON or xPON part of network for dedicated Gem (Gpon Encapsulation method) port. In general, the GEM port provides segmented connection used to classify service traffic.

In an embodiment of the present disclosure, software instances running in compute infrastructure of the first central office 102 and the second central office 104 undergoes isolation under a process called containerization. In general, containerization is a lightweight alternative to full machine virtualization that involves encapsulating an application in a container with its own operating environment. In an embodiment of the present disclosure, aggregation underlay fabric is provided isolation using eBGP at the first central office 102 and the second central office 104. In general, eBGP (External Border Gateway Protocol) is a term or process used while referring to BGP peers or neighbors that are in a different Autonomous System and Number (ASN). Also, eBGP is used to exchange route information between different autonomous systems. In another embodiment of the present disclosure, aggregation underlay fabric is provided isolation using VXLAN at the first central office 102 and the second central office 104. In general, VXLAN (virtual extensible LAN) is a network virtualization technology that attempts to address scalability problems associated with large cloud computing deployments. In yet another embodiment of the present disclosure, the aggregation underlay fabric is provided isolation using MPLS at the first central office 102 and the second central office 104. In general, the MPLS (Multiprotocol Label Switching) is a protocol-agnostic routing technique designed to speed up and shape traffic flows across enterprise wide area and service provider networks.

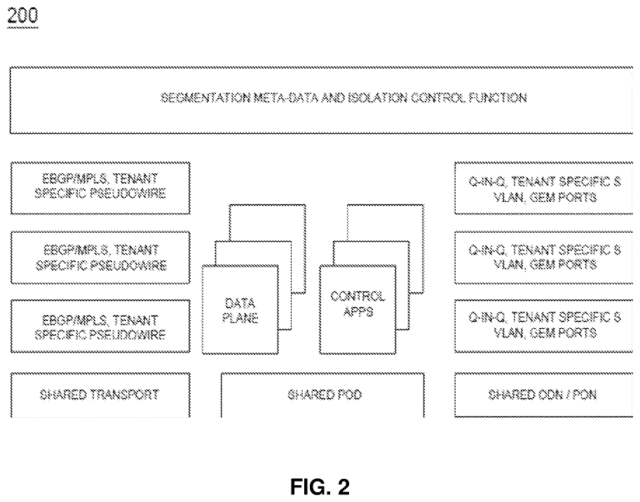

FIG. 2 a block diagram 200 of various advantages offered by shareable Fibre to the x (FTTx) network infrastructure across the one or more tenants 122 (as illustrated in FIG. 1), in accordance with various embodiments of the present disclosure. In an embodiment of the present disclosure, the programmable FTTx infrastructure provides advantage of shared transport using technologies such as eBGP, MPLS, tenant specific pseudowire, and the like. In general, pseudowire is a mechanism for emulating various networking or telecommunications services across packet-switched networks that use Ethernet, IP, or MPLS.

In an embodiment of the present disclosure, the programmable FTTx infrastructure provides advantage of shared POD (Programmable, Open, Disaggregated Solution). The programmable FTTx infrastructure provides advantage of shared POD using data plane and control applications. In an embodiment of the present disclosure, the programmable FTTx infrastructure provides advantage of shared PON or ODN (optical distribution network). In general, ODN refers to physical fiber and optical devices that distribute signals to users in a telecommunications network. The programmable FTTx infrastructure provides advantage of shared PON or ODN using Q-in-Q isolation for Ethernet, tenancy specific SVLAN, Gem ports, and the like.

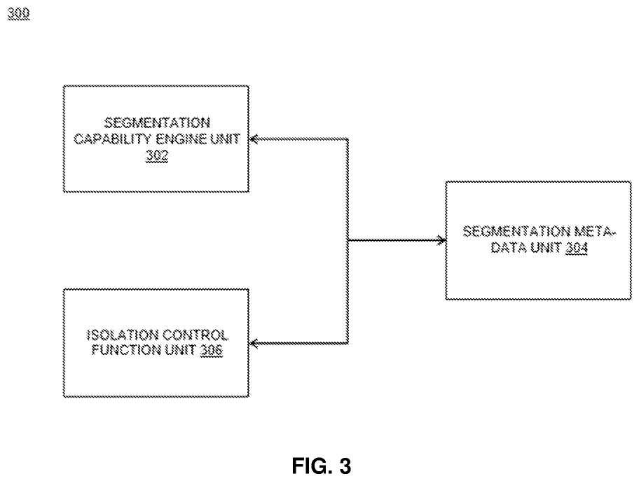

FIG. 3 illustrates a continuous and integrated isolation system 300 for providing shareable Fibre to the x (FTTx) network infrastructure across the one or more tenants 122 (as illustrated in FIG. 1), in accordance with various embodiments of the present disclosure. The continuous and integrated isolation system 300 identifies the one or more available segmentation technologies in each of the plurality of end-to-end service paths. In addition, each of the plurality of end-to-end service paths is corresponding to the plurality of tenant services of the one or more tenants 122. Further, the plurality of end-to-end service paths corresponds to the one or more disparate technology implementation. In an embodiment of the present disclosure, the one or more disparate technology implementations include Ethernet, passive optical network (PON), internet protocol (IP), and active optical networks (AON). In another embodiment of the present disclosure, the one or more disparate technology implementations include optical distribution network (ODN) and metro network and multiprotocol label switching (MPLS)

The continuous and integrated isolation system 300 encapsulates the segmentation metadata of each of the plurality of end-to-end service paths corresponding to the plurality of tenant services. In addition, the encapsulation of the segmentation metadata is hosted over the control plane. Further, the control plane is available at corresponding data center of the plurality of data centers.

The continuous and integrated isolation system 300 establishes a chain of isolation and continuous end-to-end service path corresponding to each of the plurality of tenant services. In addition, the chain of isolation and continuous end-to-end service path is established through dynamically utilizing the encapsulated segmentation metadata of the plurality of end-to-end service paths. Further, establishment of the chain of isolation and continuous end-to-end service path is hosted over the control plane. Furthermore, the control plane is available at corresponding data center of the plurality of data centers.

The continuous and integrated isolation system 300 enables interconnection of each of the one or more disparate technology implementations for seamless transition of traffic. In addition, transition of each of the one or more disparate technology implementations is done on the chain of isolation and continuous end-to-end service path. Further, the one or more available segmentation technologies are dynamically programmed for each of the one or more disparate technology implementations.

The continuous and integrated isolation system 300 includes a segmentation capability engine unit 302. In addition, the segmentation capability engine unit 302 is configured to identify the one or more available segmentation technologies. Further, the segmentation capability engine unit 302 identifies the one or more available segmentation technologies in each of the plurality of end-to-end service paths corresponding to the plurality of tenant services. Furthermore, the plurality of end-to-end service paths corresponds to the one or more disparate technology implementations.

The segmentation capability engine unit 302 includes a technology abstraction module. In addition, the technology abstraction module selects the segmentation metadata from repository of the segmentation meta-data unit 304. Further, the segmentation capability engine unit 302 includes a capability discovery engine. Furthermore, the capability discovery engine identifies the one or more available segmentation technologies in each of the one or more disparate technology implementations. Moreover, the one or more available segmentation technologies are used to leveraged for establishing tenancy requirement of the plurality of tenant services. Also, the segmentation capability engine unit 302 includes a tenancy handler module. Also, the tenancy handler module identifies tenancy requirement of the plurality of tenant services. Also, the tenancy handler module matches tenancy requirement with the one or more available segmentation technologies in accordance with the one or more disparate technology implementations.

The continuous and integrated isolation system 300 includes a segmentation meta-data unit 304. In addition, the segmentation meta-data unit 304 is connected to the segmentation capability engine unit 302 to encapsulate the segmentation metadata. Further, the segmentation meta-data unit 304 encapsulates the segmentation metadata of each of the plurality of end-to-end service paths corresponding to the plurality of tenant services. In an embodiment of the present disclosure, the segmentation metadata includes protocol buffer data, remote procedure call (RPC) data, inter-micro services data and the like. In another embodiment of the present disclosure, the segmentation metadata includes technology implementation profiles, key-value data, micro-services registry data, state data, SBI data, NBI data, and the like.

In an embodiment of the present disclosure, remote procedure call (RPC) data, protocol buffer data, and SBI data are used for control plane software to device communication. In another embodiment of the present disclosure, the remote procedure call (RPC) data, the protocol buffer data and the inter-micro services data are used for inter micro-services communication within the control plane software. In yet another embodiment of the present disclosure, technology implementation profiles, and key-value data are used to capture Micro-services registry and State-data of on-going functionalities of control plane software. In yet another embodiment of the present disclosure, NBI data/REST data are used to offer north-bound application programming interface (API). In addition, repository of the segmentation metadata is used to isolate tenancy specific profiles.

The continuous and integrated isolation system 300 includes an isolation control function unit 306. The isolation control function unit 306 is configured to receive the encapsulated segmentation metadata. In addition, the isolation control function unit 306 establishes the chain of isolation and continuous end-to-end service path corresponding to each of the plurality of tenant services.

The isolation control function unit 306 includes a device agent module. In addition, the device agent module allows abstraction over a plurality of devices used in shareable Fibre to the x (FTTx) network infrastructure. Further, the plurality of devices includes optical line terminal (OLT), optical network unit (ONU), customer-premises equipment (CPE) gateways, switch fabric, one or more aggregation switches, and the like. Furthermore, the isolation control function unit 306 includes an adapter agent module. Moreover, the adapter agent module allows inter-working of each of the plurality of device.

The isolation control function unit 306 includes a logical device agent. In addition, the logical device agent sets logical partitioning of the device agent module based on the one or more available segmentation technologies and the chain of isolation and continuous end-to-end service path. Further, the isolation control function unit 306 includes a technology handler module. Furthermore, the technology handler module leverages technology requirements of the one or more available segmentation technologies to enforce corresponding encapsulation mechanism;

The isolation control function unit 306 includes a chaining handler module. In addition, the chaining handler module establishes the chain of isolation and continuous end-to-end service path corresponding to each of the plurality of tenant services through dynamically utilizing the encapsulated segmentation metadata. Further, the chaining handler module maintains tenancy requirement of the plurality of tenant services. Furthermore, isolation control function unit 306 includes an isolation controller module. Moreover the isolation controller module enables interconnection of each of the one or more disparate technology implementations for seamless transition of traffic on the chain of isolation and continuous end-to-end service path. Also, the isolation controller module establishes integrated working of each of the one or more disparate technology implementations.

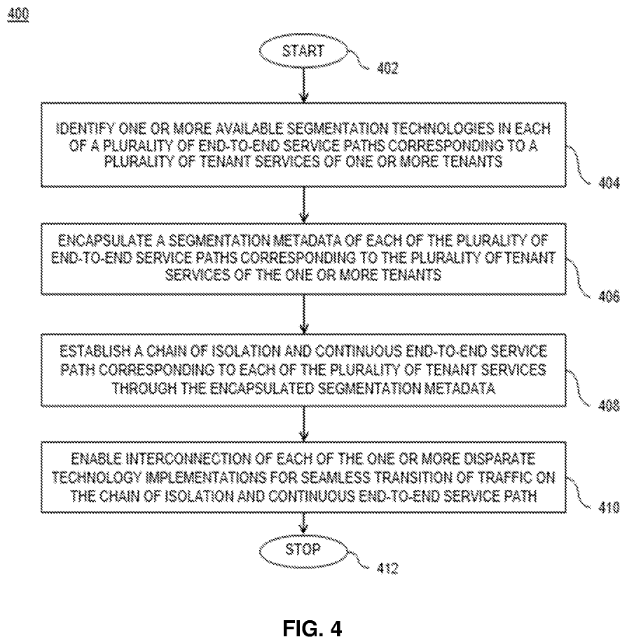

FIG. 4 illustrates a flowchart 400 of a method for providing shareable Fibre to the x (FTTx) network infrastructure across the one or more tenants 112 (as illustrated in FIG. 1), in accordance with various embodiments of the present disclosure. It may be noted that in order to explain the method steps of the flowchart 400, references will be made to the elements explained in FIG. 3. The flow chart 400 starts at step 402. At step 404, the continuous and integrated isolation system 300 identifies the one or more available segmentation technologies in each of the plurality of end-to-end service paths corresponding to the plurality of tenant services. At step 406, the continuous and integrated isolation system 300 encapsulates the segmentation metadata of each of the plurality of end-to-end service paths corresponding to the plurality of tenant services. At step 408, the continuous and integrated isolation system 300 establishes the chain of isolation and continuous end-to-end service path corresponding to each of the plurality of tenant services through the encapsulated segmentation metadata. At step 410, the continuous and integrated isolation system 300 enables interconnection of each of the one or more disparate technology implementations for seamless transition of traffic on the chain of isolation and continuous end-to-end service path.

The flow chart 400 terminates at step 412. It may be noted that the flowchart 400 is explained to have above stated process steps; however, those skilled in the art would appreciate that the flowchart 400 may have more/less number of process steps which may enable all the above stated embodiments of the present disclosure.

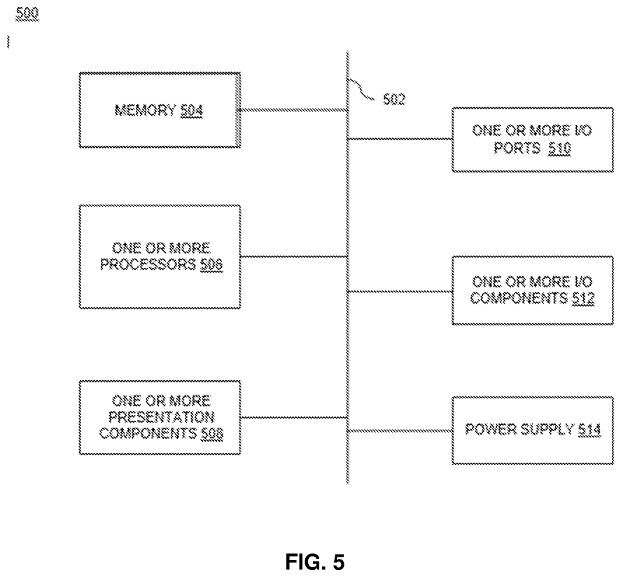

FIG. 5 illustrates the block diagram of a computing device 500, in accordance with various embodiments of the present disclosure. The computing device 500 includes a bus 502 that directly or indirectly couples the following devices: memory 504, one or more processors 506, one or more presentation components 508, one or more input/output (I/O) ports 510, one or more input/output components 512, and an illustrative power supply 514. The bus 502 represents what may be one or more busses (such as an address bus, data bus, or combination thereof). Although the various blocks of FIG. 5 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 5 is merely illustrative of an exemplary computing device 500 that can be used in connection with one or more embodiments of the present invention. Distinction is not made between such categories as “workstation,” “server,” “laptop,” “hand-held device,” etc., as all are contemplated within the scope of FIG. 5 and reference to “computing device.”

The computing device 500 typically includes a variety of computer-readable media. The computer-readable media can be any available media that can be accessed by the computing device 500 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any method or technology for storage of information such as computer-readable instructions, data structures, program modules or other data.

The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 500. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 504 includes computer-storage media in the form of volatile and/or nonvolatile memory. The memory 504 may be removable, non-removable, or a combination thereof. Exemplary hardware devices include solid-state memory, hard drives, optical-disc drives, etc. The computing device 500 includes one or more processors that read data from various entities such as memory 504 or I/O components 512. The one or more presentation components 508 present data indications to a user or other device. Exemplary presentation components include a display device, speaker, printing component, vibrating component, etc. The one or more I/O ports 510 allow the computing device 500 to be logically coupled to other devices including the one or more I/O components 512, some of which may be built in. Illustrative components include a microphone, joystick, game pad, satellite dish, scanner, printer, wireless device, etc.

The present disclosure has numerous advantages over the prior art. The programmable FTTx infrastructure provides advantage of reduced OPEX and CAPEX costs. In general, OPEX (operating expense) is an expense required for day-to-day functioning of a business. In general, CAPEX (capital expense) is an expense incurred by a business to create benefit in future. The present disclosure provides advantage of release of capital assets. The programmable FTTx infrastructure allows lesser duplication of hardware resources required for functioning of network.

The programmable FTTx infrastructure allows expansion of network and coverage over the existing FTTx infrastructure. The programmable FTTx infrastructure provides lower service prices over the existing FTTx infrastructure. The programmable FTTx infrastructure provides reduced visual and environmental impact over the existing FTTx infrastructure. The programmable FTTx infrastructure allows increase in take up and connectivity over the existing FTTx infrastructure. The programmable FTTx infrastructure provides numerous economic and social benefits over the existing FTTx infrastructure.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

Although the present disclosure has been explained in relation to its preferred embodiment(s) as mentioned above, it is to be understood that many other possible modifications and variations can be made without departing from the spirit and scope of the inventive aspects of the present invention. It is, therefore, contemplated that the appended claim or claims will cover such modifications and variations that fall within the true scope of the invention.

What is claimed is:

1. A method for providing shareable Fibre to the x (FTTx) network infrastructure across one or more tenants, the method comprising:
identifying one or more available segmentation technologies in each of a plurality of end-to-end service paths corresponding to a plurality of tenant services of the one or more tenants, wherein the plurality of end-to-end service paths corresponds to one or more disparate technology implementations;
encapsulating a segmentation metadata of each of the plurality of end-to-end service paths corresponding to the plurality of tenant services of the one or more tenants;
establishing a chain of isolation and continuous end-to-end service path corresponding to each of the plurality of tenant services through dynamically utilizing the encapsulated segmentation metadata of the plurality of end-to-end service paths; and
enabling interconnection of each of the one or more disparate technology implementations for seamless transition of traffic on the chain of isolation and continuous end-to-end service path.

2. The method as recited in claim 1, wherein the one or more disparate technology implementations comprises an Ethernet, a passive optical network (PON), an internet protocol (IP), active optical networks (AON), an optical distribution network (ODN), and a metro network and multiprotocol label switching (MPLS).

3. The method as recited in claim 1, wherein the encapsulation of the segmentation metadata and establishment of the chain of isolation and continuous end-to-end service path are hosted over a control plane, wherein the control plane is available at corresponding data center of a plurality of data centers.

4. The method as recited in claim 1, wherein the one or more available segmentation technologies are dynamically programmed for each of the one or more disparate technology implementations.

5. A continuous and integrated isolation system for providing shareable Fibre to the x (FTTx) network infrastructure across one or more tenants, the continuous and integrated isolation system comprising:
a segmentation capability engine unit configured for identifying one or more available segmentation technologies, wherein the segmentation capability engine unit identifies the one or more available segmentation technologies in each of a plurality of end-to-end service paths corresponding to a plurality of tenant services of the one or more tenants, wherein the plurality of end-to-end service paths corresponds to one or more disparate technology implementations;
a segmentation meta-data unit, wherein the segmentation meta-data unit is connected to the segmentation capability engine unit for encapsulating a segmentation metadata, wherein the segmentation meta-data unit encapsulates the segmentation metadata of each of the plurality of end-to-end service paths corresponding to the plurality of tenant services of the one or more tenants; and
an isolation control function unit, wherein the isolation control function unit is configured for receiving the encapsulated segmentation metadata, wherein the isolation control function unit establishes a chain of isolation and continuous end-to-end service path corresponding to each of the plurality of tenant services.

6. The continuous and integrated isolation system as recited in claim 5, wherein the segmentation capability engine unit comprising:
a technology abstraction module, wherein the technology abstraction module selects the segmentation metadata from repository of the segmentation meta-data unit;
a capability discovery engine, wherein the capability discovery engine identifies the one or more available segmentation technologies in each of the one or more disparate technology implementations, wherein the one or more available segmentation technologies are used to leveraged for establishing tenancy requirement of the plurality of tenant services; and
a tenancy handler module, wherein the tenancy handler module identifies tenancy requirement of the plurality of tenant services, wherein the tenancy handler module matches tenancy requirement with the one or more available segmentation technologies in accordance with the one or more disparate technology implementations.

7. The continuous and integrated isolation system as recited in claim 5, wherein the segmentation meta-data unit encapsulates the segmentation metadata, wherein the segmentation metadata comprising protocol buffer data, remote procedure call (RPC) data, inter-micro services data, technology implementation profiles, key-value data, micro-services registry data, state data, SBI data, and NBI data.

8. The continuous and integrated isolation system as recited in claim 5, wherein the isolation control function unit comprising:
a device agent module, wherein the device agent module allow abstraction over a plurality of devices used in shareable Fibre to the x (FTTx) network infrastructure, wherein the plurality of devices comprising optical line terminal (OLT), optical network unit (ONU), customer-premises equipment (CPE) gateways, switch fabric, and aggregation switch;
an adapter agent module, wherein the adapter agent module allows inter-working of each of the plurality of device;
a logical device agent, wherein the logical device agent sets logical partitioning of the device agent module based on the one or more available segmentation technologies and the chain of isolation and continuous end-to-end service path;
a technology handler module, wherein the technology handler module leverages technology requirements of the one or more available segmentation technologies to enforce corresponding encapsulation mechanism;
a chaining handler module, wherein the chaining handler module establishes the chain of isolation and continuous end-to-end service path corresponding to each of the plurality of tenant services through dynamically utilizing the encapsulated segmentation metadata, wherein the chaining handler module maintains tenancy requirement of the plurality of tenant services; and
an isolation controller module, wherein the isolation controller module enables interconnection of each of the one or more disparate technology implementations for seamless transition of traffic on the chain of isolation and continuous end-to-end service path, wherein the isolation controller module establishes integrated working of each of the one or more disparate technology implementations.
